(19) United States
(12) Patent Application Publication
(10) Pub. No.: US 2009/0040990 A1
(43) Pub. Date: Feb. 12, 2009

(54) SYSTEMS AND METHODS FOR AVOIDING AVALANCHE EFFECT IN COEXISTING WIRELESS NETWORKS

(75) Inventors: Ariton E. XHAFA, Plano, TX (US); Xiaolin LU, Plano, TX (US); Shantanu KANGUDE, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/174,341

(22) Filed: Jul. 16, 2008

Related U.S. Application Data
(60) Provisional application No. 60/954,877, filed on Aug. 9, 2007.

(51) Int. Cl. H04Q 7/24

(52) U.S. Cl. 370/338

(57) ABSTRACT

Systems and methods for avoiding access point transmission rate fall-back mechanism having an avalanche effect when acknowledgements are not received for packets sent during co-existence of WLAN and other wireless network technologies. A receiver comprises at least two dissimilar network technology subsystems. In some embodiments, a transmitter transmits a handshake to the receiver prior to transmission of at least one data packet and does not reduce a transmission rate of future transmissions to the receiver if the transmitter does not receive a reply to the handshake. In other embodiments, the receiver is able to send an indicator to a transmitter requesting a protection mechanism be employed prior to transmission by the transmitter of at least one data packet. In further embodiments, the receiver is able to negotiate with the transmitter for the transmitter to employ a protection mechanism prior to transmission of at least one data packet to the receiver.

### CROSS-REFERENCE TO RELATED APPLICATION

The present application claims priority to U.S. provisional patent application Ser. No. 60/954,877, filed Aug. 9, 2007, and entitled “Avoiding Avalanche Effect in Coexisting Wireless Network”, hereby incorporated in its entirety herein by reference.

### BACKGROUND

Next generation mobile devices will be able to access a variety of network technologies including, for example, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc. While such increased access will benefit users and operators alike, interference among such different technologies onboard a single device introduces operational difficulties.

For example, and as illustrated in FIG. 1, WLAN (in 2.4-2.5 GHz) and other technologies, such as Bluetooth (BT), WiMAX, etc. operate at relatively close frequency bands with respect to each other. Therefore, the interference between these technologies operating within the same device creates challenges on the coexistence of the corresponding interfaces of that device. As a result, various solutions are needed to enable the technologies competition for device resources to be less apparent and less inconvenient to users.

### BRIEF DESCRIPTION OF THE DRAWINGS

For a detailed description of exemplary embodiments of the invention, reference will be made to the accompanying drawings in which:

FIG. 1 illustrates different network technologies and their operating bands;

FIG. 2 illustrates an example wireless local area network (WLAN) with an access point and a plurality of wireless devices/stations, according to embodiments;

FIG. 3 illustrates an exemplary access point and/or wireless device, according to embodiments;

FIG. 4 illustrates an exemplary timing diagram in which no clear to send (CTS) is received by an access point, according to embodiments;

FIG. 5 illustrates an exemplary timing diagram in which a clear to send (CTS) is received by an access point, according to embodiments;

FIG. 6 illustrates an exemplary high throughput-extended capabilities field, according to embodiments;

FIG. 7 illustrates an exemplary high throughput control field, according to embodiments; and

FIG. 8 illustrates an exemplary method of communicating, according to embodiments.

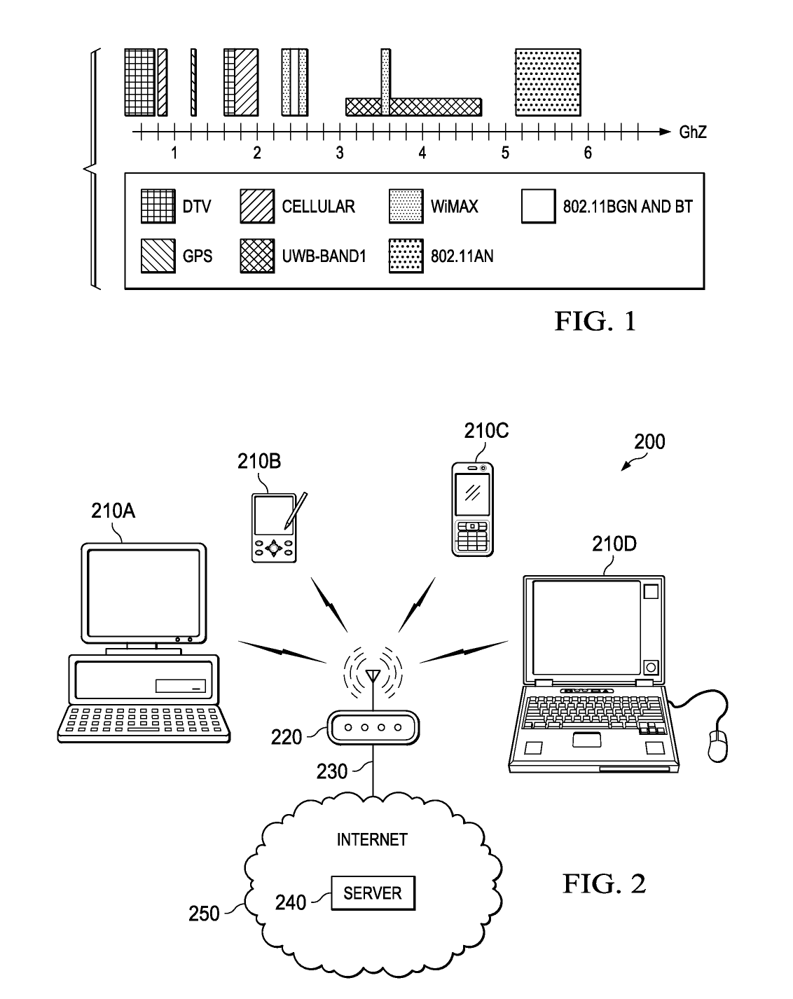

### NOTATION AND NOMENCLATURE

Certain terms are used throughout the following description and claims to refer to particular system components. As one skilled in the art will appreciate, computer companies may refer to a component by different names. This document doe not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

In working toward solving the coexistence problem, especially when WLAN technology is one of a plurality of network technology subsystems operating in a same device, time multiplexed operation among the onboard network technology subsystems is useful. For example, and not by way of limitation, in the case of WLAN and BT coexistence, BT voice calls may have priority over other traffic flows in a WLAN. As part of time multiplexed operation, during the time periods that the device operates in active BT mode, the WLAN services on the same device preferably operate in unscheduled automatic power saving delivery (U-APSD) mode. When the device switches to operate in active WLAN mode, it sends a trigger frame (or a PS-Poll) to the access point (AP) indicating that the device is ready to act as a receiver, e.g., to receive packets of information. The AP may also be referred to herein as a transmitter, e.g., a transmitter of data packets. For the sake of discussion at this point, assume the transmitted packets of information—normally containing data—are correctly routed to the device as the intended recipient. Transmission becomes problematic if the packets addressed to the device are sent by the AP within the time period that the device is operating in active WLAN mode but the device has insufficient time to reply with an ACK (in case of immediate acknowledgment) or the device has switched back to active BT mode (e.g., incoming voice data) and misses the packet transmitted by the AP; in either case, no ACK would be sent by the device. As a further example, if the packets sent by the AP are not sent within the time interval that the device is operating in active WLAN mode, again no ACK would be sent by the device.

When the AP fails to receive an ACK from its intended recipient device, a transmission rate-fall back mechanism commences at the AP. This mechanism reduces the transmission rate used to send subsequent packets from the AP to the device based on the failure to receive an ACK from the STA. In other words, when the AP transmits a packet to the intended device—also referred to herein as a STAtion (STA)—and the AP receives no corresponding ACK from that device/STA, then the AP reduces the current transmission rate to a lower (slower) transmission rate because the AP assumes the communication channel between itself and the STA is bad.

Although the packet size does not change, as the transmission rate decreases, the total duration of the packet lengthens, which in turn results in an increased probability that the duration of the AP wireless transmission and the time the device is involved with a BT reception will time-wise overlap. Worse, as the packets transmitted over the channel medium occupy ever-lengthening intervals, the corresponding probability of a collision (time-wise overlapping) with the use by the device/STA of the medium on behalf of a different network technology subsystem (in the present example, in active BT mode), quickly increases. With the increased probability of collisions comes increased likelihood of the AP more often failing to receive an ACK, and in response continuing to lower the transmission rate (thereby increasing the duration of the transmission of the packet and, naturally, increasing the probability of a further collision such that the STA fails (again) to receive the packet, and fails (again) to send an ACK. It can be quickly appreciated that as this cycle proceeds, performance of the device STA rapidly deteriorates. This is unacceptable for many reasons, including violation of QoS (quality of service) requirements. Another reason stems from the practice of an AP to continue reducing the transmission rate until reaching a predetermined threshold, at which time the AP may unilaterally disconnect the device/STA from the network because the AP would not be able to transfer much if anything at all to the device above that threshold. The rapid deterioration in performance—and associated increase in probability of collision—is what will be referred to herein as an “avalanche effect” because, as time progresses, the message becomes buried and unrecoverable/lost. Simply, the avalanche effect reflects the phenomenon that the probability of losing a packet, and risk of potentially being unwillingly disconnected from the system, increases as the rate of transmission decreases.

In light of the foregoing, embodiments provide communication systems and methods to avoid triggering the AP transmission rate fall-back mechanism when acknowledgements are not received for packets sent during coexistence in a device/STA of a plurality of network technologies (e.g., WLAN and other wireless network technologies). As a result, embodiments also avoid the associated avalanche effect. As can be appreciated, avoiding the transmission rate fall-back mechanism improves the performance of the overall network resources, and not just a co-existing WLAN network.

FIG. 2 illustrates an example wireless local area network (WLAN) 200 with a plurality of wireless devices/stations—referred to individually herein as device, station, STA or device/station—and an access point (AP), according to embodiments. It should be appreciated that the network of FIG. 2 is meant to be illustrative and not meant to be exhaustive; for example, it should be appreciated that more, different or fewer communication systems, devices and/or paths may be used to implement embodiments. To provide wireless data and/or communication services (e.g., telephone services, Internet services, data services, messaging services, instant messaging services, electronic mail (email) services, chat services, video services, audio services, gaming services, etc.), the exemplary WLAN 200 comprises AP 220 and any of a variety of fixed-location and/or mobile wireless devices or stations (STAs), four of which are respectively designated in FIG. 2 with reference numerals 210A, 210B, 210C and 210D. Exemplary devices 210 include any variety of personal computer (PC) 210A with wireless communication capabilities, a personal digital assistant (PDA) 210B, an MP3 player, a wireless telephone 210C (e.g., a cellular phone, a Voice over Internet Protocol (VoIP) telephonic functionality, a smart phone, etc.), and a laptop computer 210D with wireless communication capabilities, etc. At least one of AP 220 and STAs 210A-D are preferably implemented in accordance with at least one wired and/or wireless communication standard (e.g., from the IEEE 802.11 family of standards). Further, at least one device 210 comprises a plurality of co-existing wireless network technology subsystems onboard the at least one device 210.

In the example of FIG. 2, to enable the plurality of devices/STAs 210A-D to communicate with devices and/or servers located outside WLAN 200, AP 220 is communicatively coupled via any of a variety of communication paths 230 to, for example, any of a variety of servers 240 associated with public and/or private network(s) such as the Internet 250. Server 240 may be used to provide, receive and/or deliver, for example, any variety of data, video, audio, telephone, gaming, Internet, messaging, electronic mail, etc. service.

Additionally or alternatively, WLAN 200 may be communicatively coupled to any of a variety of public, private and/or enterprise communication network(s), computer(s), workstation(s) and/or server(s) to provide any of a variety of voice service(s), data service(s) and/or communication service(s).

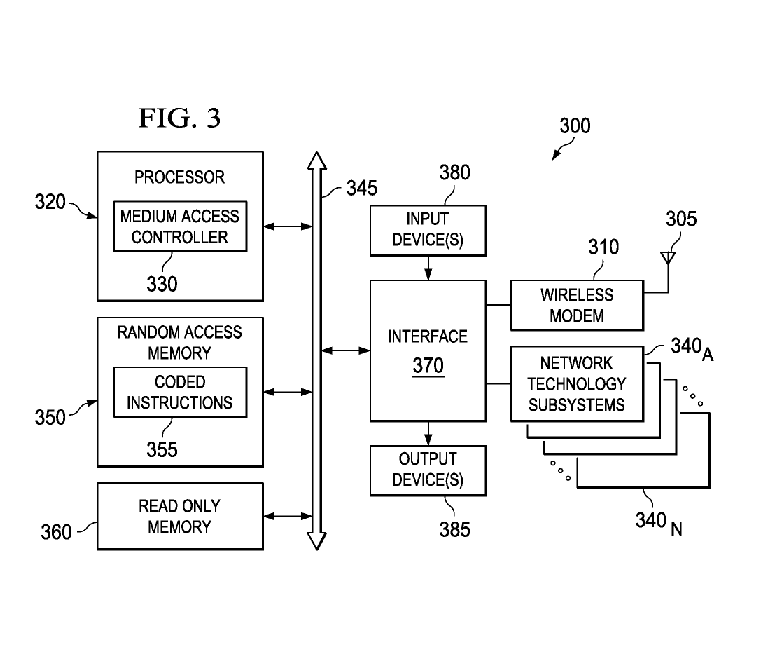

The systems and methods described herein may be implemented on any general-purpose computer with sufficient processing power, memory resources, and network throughput capability to handle the necessary workload placed upon it. FIG. 3 illustrates an exemplary, general-purpose computer system suitable for implementing at least one embodiment of a system to respond to signals as disclosed herein. Illustrated exemplary device 300 which may be an access point and/or wireless device, according to embodiments. It should be expressly understood that any device on, for example, WLAN 200 or other embodiments, may at times be an access point and at other times be a station. It should also be understood that in some embodiments, there may be at least one dedicated access point, with any number of devices acting as stations.

Device 300 comprises at least one of any of a variety of radio frequency (RF) antennas 305 and any of a variety of wireless modems 310 that supports wireless signals, wireless protocols and/or wireless communications (e.g., according to IEEE 802.11n). RF antenna 305 and wireless modem 310 are able to receive, demodulate and decode WLAN signals transmitted to and/or within a wireless network. Likewise, wireless modem 310 and RF antenna 305 are able to encode, modulate and transmit wireless signals from device 300 to and/or within a wireless network. Thus, RF antenna 305 and wireless modem 310 collectively implement the “physical layer” (PHY) for device 300. It should be appreciated that device 300 is communicatively coupled to at least one other device and/or network (e.g., a local area network (LAN), the Internet 250, etc.). It should further be understood that illustrated antenna 305 represents one or more antennas, while the illustrated wireless modem 310 represents one or more wireless modems.

The exemplary device 300 further comprises processor(s) 320. It should be appreciated that processor 320 may be at least one of a variety of processors such as, for example, a microprocessor, a microcontroller, a central processor unit (CPU), a main processing unit (MPU), a digital signal processor (DSP), an advanced reduced instruction set computing (RISC) machine (ARM) processor, etc. Processor 320 executes coded instructions 355 which may be present in a main memory of the processor 320 (e.g., within a random-access memory (RAM) 350) and/or within an on-board memory of the processor 320. Processor 320 communicates with memory (including RAM 350 and read-only memory (ROM) 360) via bus 345. RAM 350 may be implemented by DRAM, SDRAM, and/or any other type of RAM device; ROM 360 may be implemented by flash memory and/or any other type of memory device.

Processor 320 implements MAC 330 using one or more of any of a variety of software, firmware, processing thread(s) and/or subroutine(s). MAC 330 provides medium access controller (MAC) functionality and further implements, executes and/or carries out functionality to facilitate, direct and/or cooperate in avoiding avalanche effect. MAC 330 is implemented by executing one or more of a variety of software, firmware, processing thread(s) and/or subroutine(s) with the example processor 320; further, MAC 330 may be, additionally or alternatively, implemented by hardware, software, firmware or a combination thereof, including using an application specific integrated circuit (ASIC), a programmable logic device (PLD), a field programmable logic device (FPLD), discrete logic, etc.

Device 300 also preferably comprises at least one input device 380 (e.g., keyboard, touchpad, buttons, keypad, switches, dials, mouse, track-ball, voice recognizer, card reader, paper tape reader, etc.) and at least one output device 385 (e.g., liquid crystal display (LCD), printer, video monitor, touch screen display, a light-emitting diode (LED), etc.)—each of which are communicatively connected to interface 370.

Interface 370, additionally or alternatively, communicatively couples wireless modem 310 with processor 320 and/or MAC 330. Interface 370 enables interface to, for example and not by way of limitation, Ethernet cards, universal serial bus (USB), token ring cards, fiber distributed data interface (FDDI) cards, network interface cards, wireless local area network (WLAN) cards, etc. to enable device 300 to communicate with other devices and/or communicate via Internet 250 or at least one intranet. With such a network connection, it is contemplated that processor(s) 320 would be able to receive information from at least one type of network technology, and/or output information to at least one type of network technology in the course of performing the herein-described processes. It should be appreciated that interface 370 implements at least one of a variety of interfaces, such as an external memory interface, serial port, communication internal to device 300, general purpose input/output, etc.

Device 300 further comprises at least two dissimilar network technology subsystems 340; as a result, device 300 is said to have co-existing network technology. “Dissimilar” is used in this context to mean that at least one of the subsystems 340 is from a different network technology than another one of the subsystems 340. It should be understood that some embodiments of subsystems 340 may have their own dedicated wireless modem and antenna, while other embodiments may share either or both of a wireless modem and antenna. Embodiments of device 300 comprise at least two wireless network technology subsystems 340. FIG. 3 illustrates network technology subsystems 340_{A}-340_{N}, where N=the number network technology subsystems in device 300. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, etc. Processor 320 interacts with network technology subsystems 340 via interfaces implemented by interface 370.

According to some embodiments, and in order for the AP to more effectively employ a protection mechanism (e.g., RTS/CTS handshake) for transmissions of packets in specified network technologies—or alternatively transmissions of all packets—to the STA/device operating in coexistence mode, the AP is preferably alerted in advance that a protection mechanism is desired. In some embodiments, the AP is alerted upon initial association between the device and the AP; in other embodiments, the AP is alerted subsequent to the initial association, but prior to the device becoming involved with at least one further network technology in addition to its WLAN (network technology) subsystem (e.g., when the device begins to receive BT transmissions, etc.). Thus, in at least some embodiments, device/STA 210 indicates to AP 220 that device 210 is participating in more than one wireless network technology transmission, one of which is WLAN transmission—and at least one which is not—and special transmission protection by the AP (e.g., an additional protection mechanism or protocol) is requested. As a result of this notification, in embodiments, transmissions in WLAN with the device preferably start with handshake protection mechanisms before any data exchange takes place between the AP and the device.

When traffic flows are from the access point to the STA/device, the AP should, according to at least some embodiments, start sending data after a protection mechanism has been successful, e.g., a clear-to-send (CTS) has been received from the device in response to the AP's transmission of a request-to-send to the device. If, as in this particular example, the protection mechanism is an RTS/CTS handshake, the AP sends an RTS frame and waits for a corresponding CTS response from the device. A number of outcomes are possible. First, it is possible that the STA/device did not receive RTS because it was busy with a different network technology subsystem, e.g., receiving a BT voice transmission, receiving or making a VoIP transmission, etc. Hence, the AP will not receive a CTS response and, as agreed, the AP will not transmit the data frame(s) to the STA/device. More important, the AP does not change the transmission rate for subsequent transmissions (retransmission of this packet and/or transmissions of future data packets) in response to receiving no CTS response from the device.

Another possible outcome to the AP sending an RTS frame is that the STA/device does receive the RTS, however, the host of the device determines that there is insufficient time remaining in the transmission opportunity to send a CTS response, to receive the data and reply with an ACK. Therefore, the STA/device unilaterally decides to not reply with a CTS response and, as agreed, because the AP does not receive the expected CTS response, the AP will not start transmitting data frames to the STA/device. Once again, the AP does not change the transmission rate for subsequent transmissions (retransmission of this packet and/or transmissions of future data packets) in response to receiving no CTS response from the device.

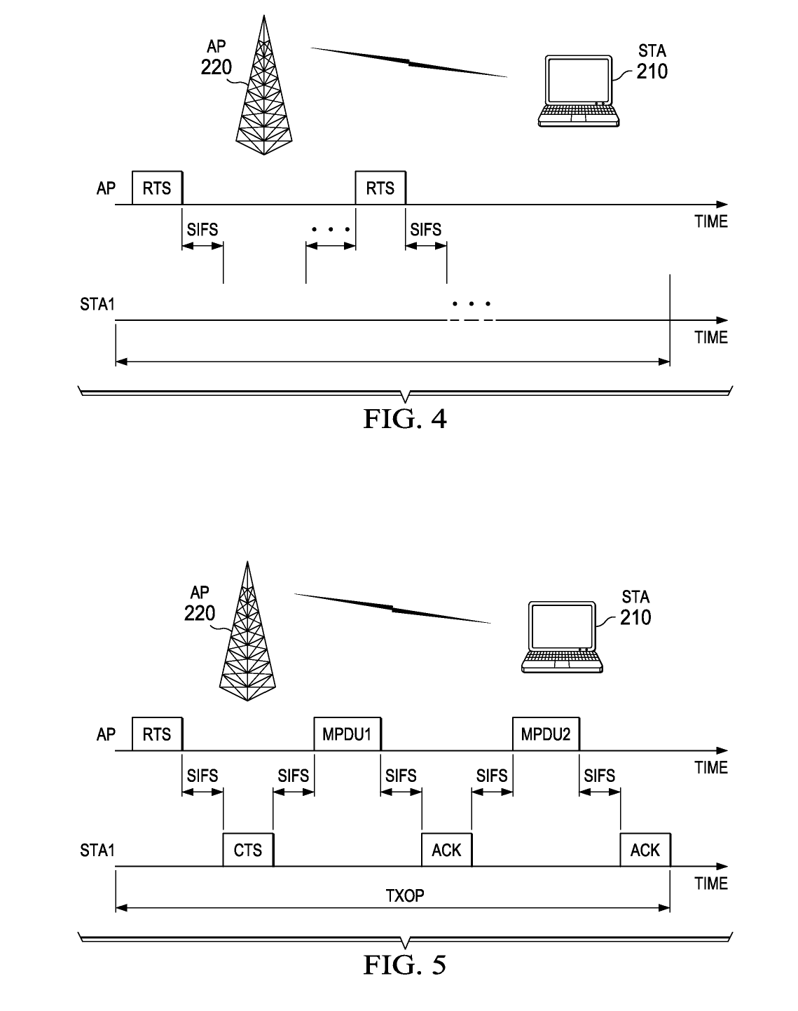

As illustrated in FIG. 4, according to some embodiments, when the AP sends the agreed RTS frame, it waits a period of time (e.g., a short interframe space (SIFS) time plus the anticipated time for a reply (CTS) plus another SIFS) to receive the expected CTS reply from the device. If it does not receive such a reply, AP 220 backs off or defers because it assumes a collision occurred. AP 220 increases its waiting time a random amount of time based on back-off procedures. After waiting, and winning contention (right to transmit) again to the device/STA 210, if needed, AP 220 sends the RTS frame to the device again. In some embodiments, AP 220 continues to resend the RTS frame in response to receiving no CTS frame from the device/STA 210 for up to a predetermined number of times. It should be appreciated that, according to at least some embodiments, AP 220 defers and retransmits the RTS frame the next time AP 220 wins contention for the wireless medium.

Of course, another possible outcome (illustrated in FIG. 5) to the AP sending an RTS frame is that the STA receives the RTS frame and the host of the device/STA determines that there is indeed sufficient time remaining in the transmission opportunity to reply with a CTS response, receive the data, and ACK reply. Therefore, the device replies to the AP with a CTS response. After receiving the CTS response, the AP starts transmitting the data frames to the STA. In the exemplary illustration of FIG. 5, consistent with some embodiments, AP 220 sends a request to send (RTS) message to STA. After waiting a short interframe space (SIFS) time, STA 210 replies with a clear to send (CTS) message. After waiting the SIFS, transmitting station AP 220 sends a data frame from its MAC protocol data unit (MPDU) and waits for an acknowledgement (ACK) by receiving STA 210. The ACK is sent by receiving device/STA 210 if the data packet is correctly received. After waiting SIFS, AP 320 transmits the next batch of bits in the MPDU (identified as MPDU2 in FIG. 5).

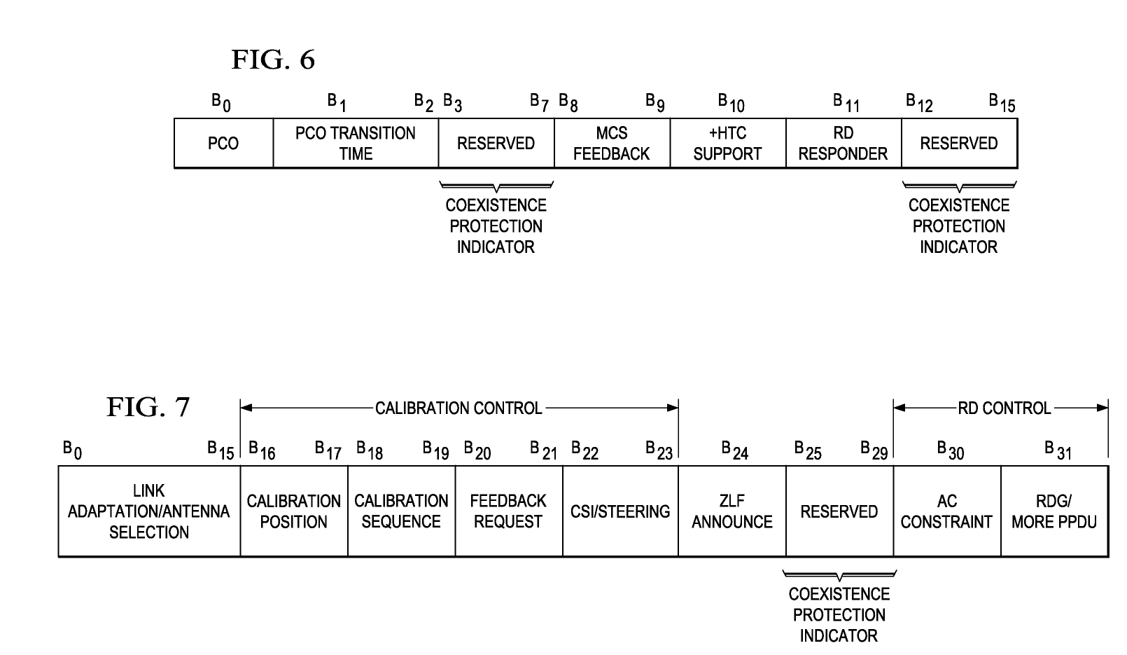

Some embodiments include a separate field within the high throughput (HT) capabilities field to indicate that the STA/device requests the use of a protection mechanism (e.g., a RTS/CTS handshake) before the data frames are to be sent to this STA/device. By employing such implementation, these embodiments operate independent of the power-saving mode that the STA/device is using when in WLAN U-APSD. Moreover, such implementations do not affect the size of the MAC protocol data unit (MPDU). FIG. 6 illustrates embodiments having a Coexistence Protection Indicator (CPI) occupy a one-bit field either in reserved bit locations B₃₋₇ or B₁₂₋₁₅ within the HT-extended capabilities field. As illustrated, the HT-extended capabilities field comprises a phased coexistence operation (PCO) field, a phased coexistence transition time field, a modulation and coding scheme (MCS) feedback field, a high throughput control (HTC) field, a reverse direction (RD) field, and two reserved fields. Because, for simplicity of discussion and ease of understanding, there are only two network technology subsystems in the device under discussion, a value of one in the selected bit location preferably indicates that the requested protection mechanism (e.g., a RTS/CTS handshake) applies to all traffic flows, although it should be appreciated that other bit(s) values could be used instead. Further, it should be clearly understood that some embodiments set an appropriate number of bits, preferably in one of the reserved fields, to correspond to the traffic flow of a specific designated network technology to alert the AP that packets to be transmitted in the future involving that specific designated network technology should also trigger the particular protection mechanism, e.g., RTS/CTS handshake prior to transmission. Of course, in other embodiments, the CPI bit may alternatively indicate the presence of at least one other control field, such field(s) not necessarily confined to the RTS/CTS mechanism. Within at least one such control field, the STA may request implementation of a protection mechanism.

Further embodiments instead employ a Coexistence Protection Indicator (CPI) field as part of the high-throughput (HT) control field associated with the transmitted packets; setting an appropriate number of bits within such a field acting as an indication from the AP that a protection mechanism is in place for the transmitted packets. FIG. 7 illustrates an exemplary implementation of such embodiments when a CPI field is inserted in the HT control field, such as would be alternatively employed by some PHY layer embodiments. As illustrated, the HT control field comprises a link adaptation/antenna selection field, a calibration position field, a calibration sequence field, a feedback request field, a channel state information (CSI)/steering field, a zero length field (ZLF) announce, an access category (AC) constraint field, a reverse direction grant (RDG)/more physical layer convergence procedure (PLCP) protocol data unit (PPDU) field, and a reserved field. As can be seen, bits B₂₅₋₂₉ are reserved; it should be understood that any of these bits can be used to indicate special protection for a particular frame. Under this scenario, there is preferably only one bit change in the HT control field, which only nominally increases the overhead added to the existing protocol. These embodiments preferably have the AP and STA agree upon use of this approach prior to the CPI being enabled, e.g., upon association of the STA with the network, etc. Of course, in other embodiments, setting of a particular bit within the CPI field may alternatively indicate the presence of at least one other control field, such field(s) not necessarily confined to the RTS/CTS mechanism. Within at least one such control field, would be information relevant to implementation of an agreed-upon protection mechanism.

It should be readily appreciated that other embodiments alternatively or additionally implement different field(s) added to the associated packets in WLAN transmission, different field(s) added to other packet(s)—regardless of network technology—and bits set in other locations within the packets to support the use of a CPI.

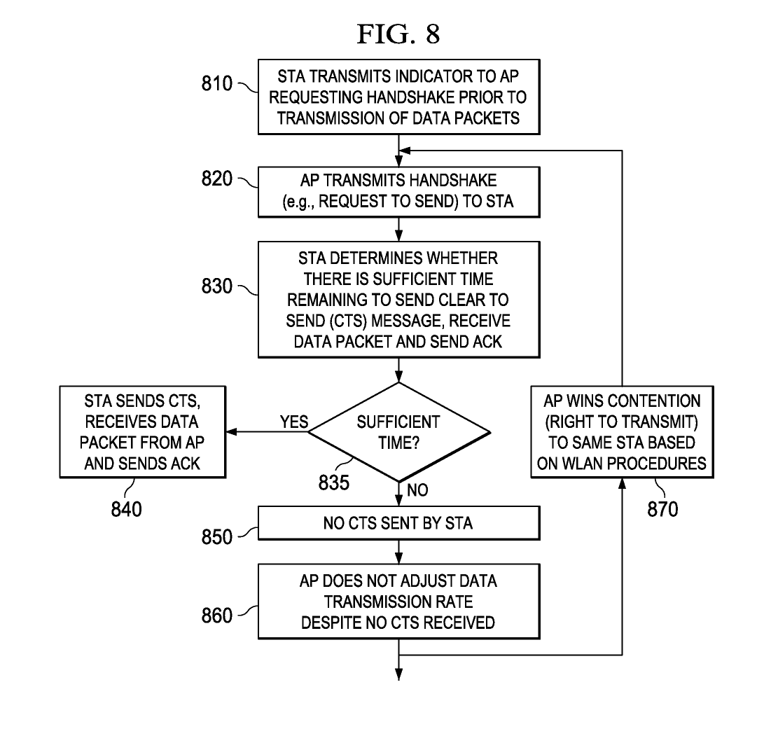

FIG. 8 illustrates an exemplary method of communicating, according to embodiments. When the STA first associates with the network including the AP, or later when the STA determines that more than one of its network technology subsystems have been activated, the device/STA transmits an indicator to the AP requesting implementation of a protection mechanism (e.g., a handshake) prior to transmission of any data packets (block 810). At block 820, the AP transmits a request to send (RTS) to the STA. Assuming the STA receives/notices/hears the request to send, the STA determines whether there is sufficient time (block 835) remaining in the transmission opportunity to send a clear to send (CTS) message, to receive the data packet and to send an ACK to acknowledge receipt of the data packet (block 830). According to embodiments, determination by the STA of “sufficient time” preferably takes into account whether there is sufficient time remaining before the device must switch to another network technology to send the CTS reply, receive the data packet from the AP and transmit an ACK. If the STA determines that there is sufficient time, the STA sends the CTS message and receives the data packet from the AP (block 840). However, if there is not sufficient time to send a CTS message, receive the data packet, and send an ACK message, the STA does not send a CTS message in response to the RTS sent by the AP (block 850). As the AP did not receive a CTS message, it does not send the data packet (block 860). In at least some embodiments, the AP repeats the process. In those embodiments, after the AP again wins the contention (right to transmit a packet) to the same device/STA, based on WLAN procedures, the process returns to block 820. As before, the AP again sends a RTS message to the STA. In these embodiments, this repetition preferably occurs a predetermined number of times before the AP ceases to try to reach the STA concerning this data packet. It should be understood that while the foregoing describes preferred embodiments, alternative embodiments exist. For example, the various functions of FIG. 8 are not necessarily sequentially performed; the functions may be performed in various orders. Additionally, each function of FIG. 8 may be repeated multiple times.

Despite the examples employed in this discussion where an ACK is the reply for every received packet, it should be understood that embodiments are also applicable to systems where there is instead a different transmission arrangement, for example and without limitation, a block-ACK arrangement (i.e., AP transmits a plurality of packets and STA responds with a single ACK identifying the packets received). Regardless of transmission arrangement, the STA preferably takes into account the amount of time granted to it by the AP in which to appropriately respond when determining whether there is sufficient time to reply.

Thus, despite the AP's failure to receive a CTS message, the AP does not decrease the transmission rate of a subsequent transmission because the transmission rate fall-back mechanism is not triggered. The fall-back mechanism is not triggered because the AP does not send the data packet first - risking the change the STA will not return an ACK (which would trigger the AP's fall-back mechanism) because the device/STA is busy using the device's resources on a different network technology with higher priority at the time and therefore fails to receive the data packet. Instead, according to embodiments, the AP employs a protection mechanism, e.g., handshake, before transmission of the data packet; failure to receive a reply to the selected protection mechanism at best requires the AP to try again to reach the STA using the protection mechanism and at worst the AP drops the one packet. Regardless, the AP does not reduce the transmission rate for subsequent transmissions to the STA.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A communications device, comprising:
a receiver comprising at least two dissimilar network technology subsystems, the receiver able to send an indicator to a transmitter of data packets requesting a protection mechanism be employed prior to transmission by the transmitter of at least one data packet.

2. The communications device of claim 1, wherein the requested protection mechanism is a handshake.

3. The communications device of claim 1, wherein the indicator requests the protection mechanism be employed prior to all transmissions of data packets from the transmitter to the receiver.

4. The communications device of claim 1, wherein the indicator requests the protection mechanism be employed prior to all transmissions of data packets to a designated one of the receiver's independent network technology subsystems.

5. The communications device of claim 1, wherein the indicator is a bit in a high throughput extended capabilities field.

6. The communications device of claim 1, wherein the receiver is able to send the indicator upon initial association with the transmitter.

7. The communications device of claim 1, wherein the protection mechanism results in the transmitter not reducing the transmission rate of future transmissions to the receiver if the transmitter does not receive a reply from the receiver.

8. The communications device of claim 1, wherein the protection mechanism is a request to send (RTS)/clear to send (CTS) handshake.

9. A communications system, comprising:
a transmitter of data packets; and
a receiver comprising at least two dissimilar network technology subsystems, the receiver able to negotiate with the transmitter for the transmitter to employ a protection mechanism prior to transmission of at least one data packet to the receiver.

10. The communications system of claim 9, wherein the requested protection mechanism is a handshake.

11. The communications system of claim 9, wherein the protection mechanism is employed prior to all transmissions of data packets from the transmitter to the receiver.

12. The communications system of claim 9, wherein the protection mechanism is employed prior to all transmissions of data packets to a designated one of the independent network technology subsystems of the receiver.

13. The communications system of claim 9, wherein part of the negotiation involves setting a bit in a high throughput extended capabilities field.

14. The communications system of claim 9, wherein part of the negotiation involves setting a bit in a high throughput control field.

15. The communications system of claim 9, wherein the receiver is able to negotiate with the transmitter upon initial association with the transmitter.

16. The communications system of claim 9, wherein the protection mechanism results in the transmitter not reducing the transmission rate of future transmissions to the receiver if the transmitter does not receive a reply from the receiver.

17. The communications system of claim 9, wherein the protection mechanism is a request to send (RTS)/clear to send (CTS) handshake.

18. A method for communicating, comprising:
transmitting a handshake, by a transmitter, to a receiver comprising at least two dissimilar network technology subsystems, the handshake transmitted prior to transmission of at least one data packet; and
not reducing a transmission rate of future transmissions to the receiver if the transmitter does not receive a reply to the handshake from the receiver.

19. The method of claim 18, further comprising requesting, by a receiver, the handshake be employed prior to transmission by the transmitter of at least one data packet, such requesting occurring prior to the transmitting.

20. The method of claim 18, further comprising determining, by the receiver, whether there is sufficient time remaining in a transmission opportunity to reply to the handshake, receive the at least one data packet, and to send an acknowledgement.

21. The method of claim 20, wherein the determining further comprises unilaterally deciding, by the receiver, to not reply to the handshake.

22. The method of claim 18, wherein the transmitting further comprises transmitting a request to send (RTS) handshake.

23. The method of claim 18, wherein the transmitting further comprises transmitting a handshake prior to all transmissions of data packets from the transmitter to the receiver.

24. The method of claim 18, wherein the transmitting further comprises transmitting a handshake prior to all transmissions of data packets to a designated one of the dissimilar network technology subsystems of the receiver.
